(19) United States
(12) Patent Application Publication
(10) Pub. No.: US 2024/0213913 A1
(43) Pub. Date: Jun. 27, 2024

(54) PHOTOVOLTAIC FILM SYSTEM

(71) Applicant: Mechoshade Systems, LLC, Middleton, WI (US)

(72) Inventors: Stephen P. Hebeisen, Amawalk, NY (US); Stanley Mayer, Rego Park, NY (US); Robert Hopkins, Flushing, NY (US)

(73) Assignee: Mechoshade Systems, LLC, Middleton, WI (US)

(21) Appl. No.: 18/545,486

(22) Filed: Dec. 19, 2023

Related U.S. Application Data
(60) Provisional application No. 63/434,228, filed on Dec. 21, 2022.

(51) Int. Cl. H02S 20/32; E06B 9/44; E06B 9/72; H02J 3/38

(52) U.S. Cl. CPC H02S 20/32; E06B 9/44; E06B 9/72; H02J 3/38; E06B 2009/2476; H02J 2300/26

(57) ABSTRACT

The system may comprise a controller configured to control one or more motors; a plurality of motors, wherein each of the plurality of motors are configured to adjust a photovoltaic (PV) film system and a window shade system; a geared interface configured to interface the PV film system and the window shade system; the PV film system may be configured to generate solar power for the controller; and a storage device that interfaces with the controller. The coupler for a PV film system may comprise a first wire that interfaces with the PV film; a rotating portion of a slip ring that interfaces with the first wire; a non-rotating portion of the slip ring that interfaces with a second wire; the second wire exiting the coupler; and an outside surface of the coupler that receives a tube, wherein the tube interfaces with the PV film.

### CROSS-REFERENCE TO RELATED APPLICATIONS

This application claims priority to, and the benefit of, U.S. provisional application Ser. No. 63/434,228 filed Dec. 21, 2022, entitled “Photovoltaic Film System”, which is incorporated by reference in its entirety for all purposes.

### TECHNICAL FIELD

This disclosure generally relates to photovoltaic film, and more particularly, to a photovoltaic film management system.

### BACKGROUND

Entities are trying to find improved energy solutions (e.g., renewable energy) to reduce their carbon footprint and to meet increasing energy demands with sustainable end to end power. Moreover, entities prefer to generate power onsite to minimize transmission and transportation costs. The entities often have offices in buildings that are typically exposed to the sun for a long period of time each day. To take advantage of the sun exposure, the buildings may incorporate a very promising energy source that includes flexible, lightweight and semi-transparent photovoltaic (PV) cells, also known as solar cells. The PV film may be attached to awnings or shades. The solar cells may also be adhered to areas that receive sunlight (e.g., windows, skylights, etc.). The semi-transparent nature of the PV film may support some level of viewing through the cells. However, in many cases, the view is not optically clear and/or may be tinted (e.g., green). Therefore, it is highly desirable to be able to remove the PV film or move the PV film out of the view for periods of the day to promote a clear view.

The PV cells may be composed of semiconductor material and be printed from organic ink. The PV cells may be electronic devices that convert the energy from light into electricity by the photovoltaic effect. The photovoltaic effect is a physical and chemical process. When the light shines on a PV cell, the light may be reflected, absorbed or pass through the cell. When the energy from the sunlight is absorbed by the PV cells, the energy creates electrical charges that move in response to an internal electrical field in the PV cell, causing electricity to flow. As such, the PV cells produce direct current electricity from sunlight which can be used to power equipment or to recharge batteries.

PV cell conversion efficiency is the percentage of incident solar energy that is converted to electricity. Conversion efficiency may vary based on the type of solar cell, the spectrum of the light source, and the amount of incident daylight energy required to activate the photovoltaic effect. In addition, some organic inks are sensitive to IR band energy where the inks absorb that energy in the conversion process for generating electricity. The PV film may be tuned to IR, so that the PV cells use the solar heat gain spectrum coming from the sun that gets trapped between the glazing and the shade, and convert the solar heat gain spectrum into electrical energy. The PV cells may be tuned to be sensitive to lower power levels, thereby allowing the PV cells to generate energy at levels lower than silicone-based PV cells. The PV cells may have broader angle sensitivity and may generate energy over broader solar angles. Combining electricity generation with reduction in solar heat gains within a building may reduce overall energy demand, along with enabling the use of renewable (net zero carbon) energy to offset the energy consumption that remains.

These types of organic films offer the ability to absorb solar heat gain and compound the energy savings by reducing the cooling load from the building HVAC system. The use of semi-transparent PV film allows a view through the material, while lowering the cost of production. It is highly desirable to have the PV film present during times when the PV film can efficiently convert energy, but retract the PV film when not efficient. Retracting the PV film would ultimately promote the more natural view (and natural colors) and allow the building and occupants to obtain direct access to daylight.

### SUMMARY

In various embodiments, the system may comprise a controller configured to control one or more motors; a plurality of motors, wherein each of the plurality of motors may be configured to adjust a photovoltaic (PV) film system and/or a window shade system; a geared interface configured to interface the PV film system and the window shade system; the PV film system configured to generate solar power for the controller; a storage device that interfaces with the controller, wherein the storage device is configured to store the solar power. The system may include a POE switch, lights, automation server and internet.

Each of the plurality of motors may be configured to adjust the window shade system, such that the adjustment to the window shade system causes an adjustment to the PV film system via the geared interface. The geared interface may include a third gear that interfaces with a first gear on the PV film system and second gear on the window shade system. The geared interface may include a first gear on the PV film system interfacing with a second gear on the window shade system. A third gear may adjust the gear ratio relative to the thickness difference between the PV film and the solar shade, so that a movement to full height for the shade equates to full height for the PV film system. The PV film system may include a PV film and the window shade system may include a window shade, wherein the PV film and the window shade share a hembar. The controller may comprise a maximum power point tracking (MPPT) charge controller. The MPPT may optimize the charging state of the battery relative to real-time solar power generation. A power over ethernet (POE) switch may interface with the controller to provide POE power to the controller (e.g., as a back-up or additive power source). An ethernet switch may interface with the controller to provide data to the controller. A control system may interface with at least one of a POE switch or an ethernet switch, wherein the control system may be configured to provide data (e.g., management and/or control data) to the controller for controlling the plurality of motors.

The PV film system may include a PV film and the window shade system may include a window shade, wherein an inside side of the PV film may be configured to receive solar rays reflected from the window shade. An inside side of the PV film may be configured to receive artificial light. A rod may be configured to push the window shade closer to a window. A rod may be configured to push a bottom of the window shade closer to a window such that the window shade is more perpendicular to solar rays. At least one of an angled windowsill or an angled block may be configured to push a bottom of the window shade closer to a window such that the window shade is more perpendicular to solar rays.

The PV film system may include a slip ring. The PV film system may include a coupler with rotation and load hanging functions separated from power connection functions. The PV film system may include a coupler that receives a tube, wherein the tube interfaces with a PV film 110, the coupler may further comprise: a first wire that interfaces with the PV film 110; a rotating portion of a slip ring that interfaces with the first wire; a non-rotating portion of the slip ring that interfaces with a second wire; and the second wire exiting the coupler. The second wire may provide solar power to the controller. The second wire may provide solar power to the MPPT charge controller.

The coupler for a PV film system may comprise a first wire that interfaces with the PV film 110; a rotating portion of a slip ring that interfaces with the first wire; a non-rotating portion of the slip ring that interfaces with a second wire; the second wire exiting the coupler; and an outside surface of the coupler that receives a tube, wherein the tube interfaces with the PV film 110.

### BRIEF DESCRIPTION OF THE DRAWINGS

The accompanying drawings, wherein like numerals depict like elements, illustrate exemplary embodiments of the present disclosure, and together with the description, serve to explain the principles of the disclosure. In the drawings:

FIG. 1 illustrates an exploded view of an exemplary system, in accordance with various embodiments.

FIG. 2 illustrates an exemplary controller system, in accordance with various embodiments.

FIG. 3 illustrates an exemplary PV film, fabric backing and circuitry, in accordance with various embodiments.

FIG. 4 illustrates an exemplary bracket for a double shade with multiple gears, in accordance with various embodiments.

FIG. 5 illustrates an exemplary geared double shade bracket, in accordance with various embodiments.

FIG. 6 illustrates an exemplary double shade system with common hembar, in accordance with various embodiments.

FIG. 7 illustrates an exemplary slip ring, in accordance with various embodiments.

FIG. 8 illustrates an exemplary bracket for a double shade system, in accordance with various embodiments.

FIG. 9 illustrates an exemplary bracket for a slip ring, in accordance with various embodiments.

### DETAILED DESCRIPTION

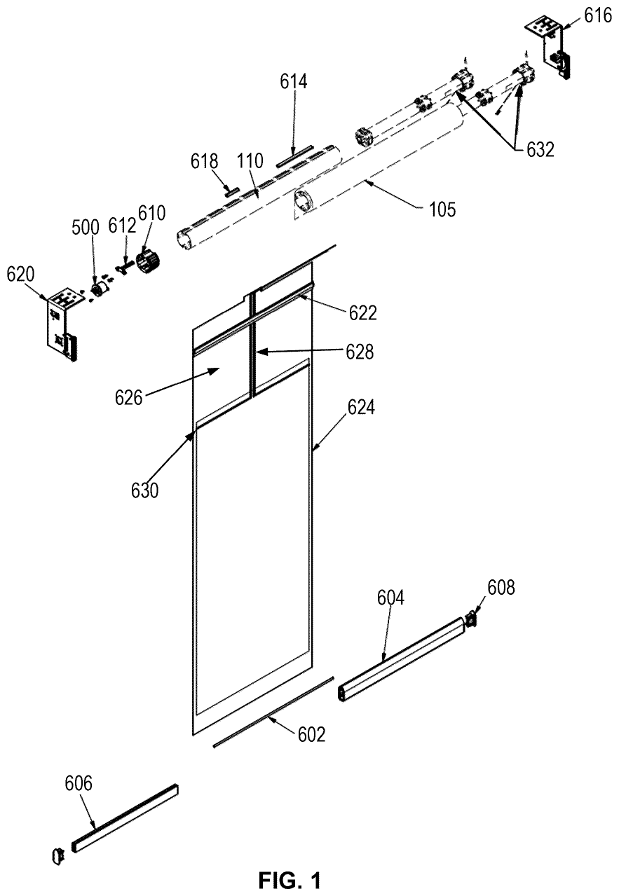

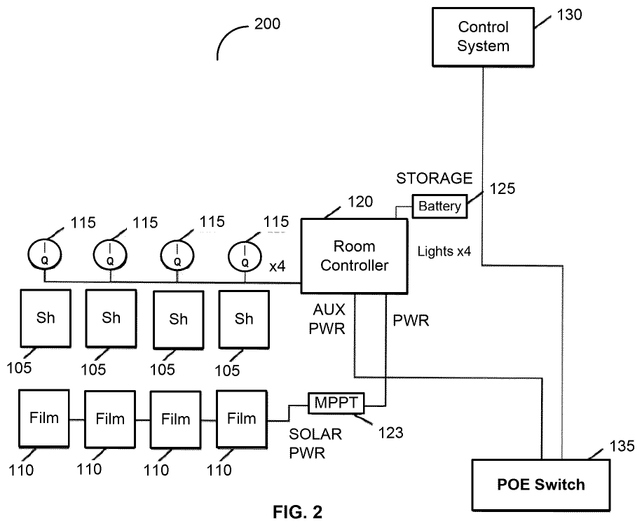

A roller shade system may provide a platform for adjusting the PV (solar) film 110 manually, through motorization and/or with automation. With respect to FIGS. 1 and 2, in various embodiments, the system 100 may include one or more window shade systems 105 and/or one or more PV film systems 110, along with various mechanical parts, electrical parts, software and controls, as discussed herein. Window shade system 105 may include one or more window shade (e.g., textile) and/or one or more window shade tube. PV film system 110 may include one or more PV cells, one or more PV films, one or more backing fabric (e.g., PTE backing or shade fabric backing) and/or one or more PV film tube. Window shade system 105 may adjust (e.g., raise and lower) a roll of textile material and PV film system 110 may adjust (e.g., raise and lower) a roll of PV film 110 (which may be mounted on PTE backing or shade fabric). As used herein, the phrases “shade” and “PV film” may be used interchangeably in this disclosure such that any configuration or feature that includes a shade may include a PV film, and any configuration that includes a PV film may include a shade.

The PV film system 110 may work with any type of PV film 110 or other PV products. The PV cells may be printed onto PTE material or other shade fabric. The fabric would then be sealed to prevent humidity from reducing the lifetime performance of the PV cells. The PV film 110 and/or PV cells may be adhered to shade fabric. A shade fabric may be welded to the solar film using adhesives and/or heat. The shade fabric may be taped to the solar film. The shade fabric can be any fabric (e.g., plastic fabric) that is weldable to other plastics. The use of the backing fabric improves shade aesthetics. The backing fabric may improve the energy absorption efficiency of the PV film. The shade fabric may be selected or changed to vary or adjust the amount or type of light that reaches the space behind the solar absorbing shade and/or that enters the room. The shade fabric may be selected or changed to optimize energy capture. The PV film on a backing fabric may be on a single tube system, while maintaining typical shade function. The PV film on a backing fabric may save space (compared to a two-shade solution) which allows the availability of more applications. The system also reduces installation costs and installation complexity. The PV film 110 may include solar heat gain absorption capabilities that can be incorporated into energy management routines.

The PV film 110 may be produced in rolls with a particular width (e.g., 21 inches wide), so the other components may be adapted to accommodate for such a width of the PV film 110. In that regard, the tube may be 32 inches long in order to hold the motor, the end cap, etc. Therefore, the tube may be wider than the PV film 110. As such, the PV film 110 may not extend over the entire width of the window, or when multiple PV films 110 are installed next to each other, a gap may exist between the PV films 110.

In various embodiments, a manual chain and/or a motor may operate the PV film system 110 (without a window shade system 105). In various embodiments, a manual chain and/or a motor may operate both the window shade system 105 and the PV film system 110. In various embodiments, a first chain and/or a first motor may operate the window shade system 105, and a second chain and/or a second motor may operate the PV film system 110.

In various embodiments, with respect to FIG. 1, the system may include one or more of any of the following components: window shade system 105, PV film system 110, hembar spline 602, exposed hembar 604, internal hembar 606, hembar finial 608, idle end plug 610, tube plug wire cover 612, slip ring 500, wire retainer 614, drive end bracket assembly 616, crimp retainer 618, idle bracket 620, spline 622, PV cells 624, PET backing 626, bus bars 628, conductors 630 and motor 632.

Tube plug wire cover 612 may help to protect the cabling from scraping against the sharp edges of the tube of the PV film system 110. Crimp retainer 618 may retain the interface or connection between the wires to allow the current to travel to other components. Motor 632 may include any motor size or power suitable to operate either or both of window shade system 105 and the PV film system 110. The system may also include a power regulator. The power regulator may interface with or be incorporated into the motor 632. The power regulator may regulate the power from the PV cells to conform to the input voltage of the motor. Spline 22 may be connected to the PTE backing with any means such as fasteners, glue, staples, magnetics, etc. When using any type of staple, any holes should be covered to avoid humidity entering the PV backing and/or the PV cells. Exposed hembar 604 may allow more weight to be added to the bottom of the PTE backing to help control the PTE backing.

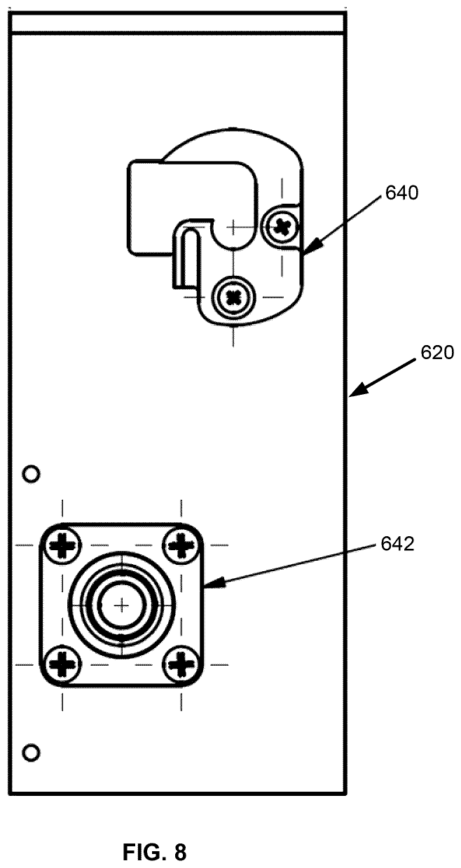

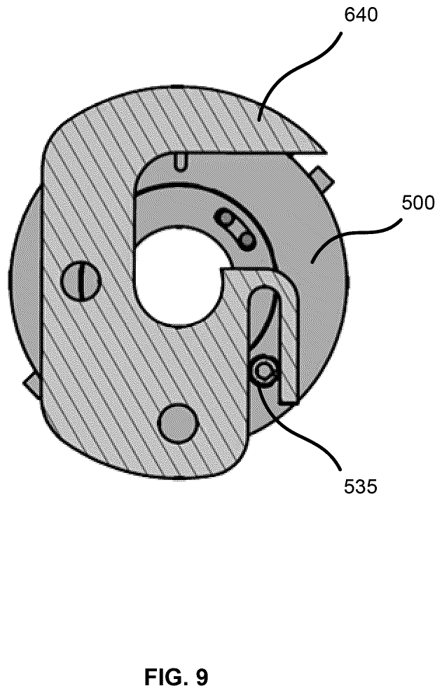

With respect to FIG. 8, in various embodiments, idle bracket 620 may include idle end slip ring adaptor 640 and idle end retainer 642. With respect to FIG. 9, in various embodiments, idle end slip ring adaptor 640 may receive an idle center pin of slip ring 500 (e.g., in a cradle portion). Idle end slip ring adaptor 640 may receive set screw 535 (e.g., in a channel).

In various embodiments, the system 100 may include one or more window shade systems 105 and/or one or more PV film 110 systems 110 housed in a pocket, housed in a cassette, mounted to surfaces (e.g., wall, window frame, ceiling, etc), mounted to surfaces with brackets. The cassette may include some or all of the components of FIG. 1, such that the cassette may be easily installed in any desired location. Because the PV cells may charge a battery that interfaces with the motor, the cassette may be self-sufficient and generate its own power to operate the motor. Therefore, the cassette may not need additional wiring to interface with a source of power.

The system may also include multiple shades (e.g., mounted next to each other), etc. The multiple cassettes or pockets may include wiring that extends through one or more of the different shade systems and PV systems. The multiple tubes may include a coupler between the tubes that interfaces with the end of a first shade tube and an end of a second shade tube. The coupler may include a keyway to enable the second tube to spin with the first tube. The coupler may include a passage to allow one or more wires (or cables) to extend from the first shade tube to the second shade tube. The one or more wires extending from the first shade tube to the second shade tube may include one or more long wires, or the wires may be connected or interface within the coupler.

The PV film 110 system may be retrofit into existing systems or installed as part of new construction. Certain PV products may be incorporated into new construction or large renovations as part of the building materials (façade, roof tiles, between window panes, etc.). However, the implementation of various features of this system do not require new construction or major renovations. In various embodiments, the PV film system 110 may be included in any type of window shade system 105 or control system 130 (with or without a window shade). For example, the PV film 110 may be configured as (or with) vertical shades (top-down, bottom-up), angled shades (with tension, without tension, spring or motor), horizontal shades, skylight with tension, curtainwalls, punched windows, wall mount, pocket mount, single band, multiple band, single bracket, dual shade bracket, etc. The system configuration may be based on the impacts of the punched window such as, for example, minimizing the amount of space within the window frame, the maximum rolled-up diameter (RUD) of the tube with the shade rolled up on the tube, minimum footprint, easy to install, easy to wire, etc. The PV cell structure may be optimized to best support the production of any size (width or height) of window.

In various embodiments, the PV films 110 may be connected to share energy. The PV films 110 may be connected with, for example, a wire, cabling, slip ring, or any other electrical connection. The wires may carry the energy from the coupler to the positive bus bar pole and/or the negative bus bar pole on the PV film 110. The connections may be parallel connections between multiple PV films 110 to increase the power level delivered to the coupler. The connections may be serial connections between multiple films to increase voltage levels on power delivered to the coupler. The PV film 110 panels may be coupled together across the width or in length by optimizing cell structure connections between cells and bus bars. The PV film 110 may be attached to the window shade fabric using, for example, any type of suitable adhesive or welding solution (ultrasonic, thermal, RF, etc.). The system may include any connection options for connecting the PV film to PV film, PV film 110 to connector, connector to spline or cabling, spline or cabling to tube, spline or cabling through tube to tube coupler 500, tube coupler 500 to bracket 505, PV film 110 to cabling 530, tube distribution, tube wiring 525 to idle center pin 502, idle center pin 502 to bracket 505, etc.

The PV film 110 is configured to roll-up and un-roll, so any connections should not impact the ability of the PV film 110 to roll. For example, any large connections may impact the surface of the PV film 110 by, for example, cutting into the PV film 110 or preventing the PV film 110 from laying flat across the tube. In various embodiments, the system may incorporate a spline that holds the PV film 110 and the spline also interfaces with the tube. For example, the spline may fit into channel within the tube. The spline may be comprised of plastic, rubber or some combination depending on the type of PV film 110 and tube configuration. The wires or cabling may run through the spline, within the channel holding the spline, within other channels in the tube and/or through the tube. In this way, the wires and cabling may not interfere with the rolling of the tube or the smooth wrapping of the PV film 110 around the tube. The PV film 110 may be configured to support sizing the PV film 110 to the window size requirements in both width and height. The PV film 110 layout may support modular cells that can be combined within the tube channel to facilitate the desired voltage and power level. Meanwhile, the PV film 110 may be fabricated such that the cutting of the PV film 110 does not degrade the lifecycle of the film due to humidity ingress. In various embodiments, the system may compensate for a lower efficiency in response to connecting multiple PV films 110 together. Lower efficiency may occur from, for example, a PV film 110 receiving less sunlight. As such, the system may extract power from a PV film 110 receiving more sunlight.

Any of the electrical connections may support bi-directional use. In particular, the system 100 may provide power and communications to a PV film system 110 and/or shade system 105 to support the motor 115 and/or electronics on the system. Such electronics may include, for example, display, user interface, light, speaker, communication technology, etc. The system may also incorporate a controller (e.g., controller 120), wires, cabling, electronic components and/or lighting in the window shade pocket or cassette. The system may incorporate any of the features or functions set forth in U.S. application Ser. No. 15/334,591 filed Oct. 26, 2016 (now U.S. Pat. No. 10,44,622 issued Jan. 28, 2020) entitled “Wired Pocket.” U.S. application Ser. No. 16/728,339 filed Dec. 27, 2019 (now U.S. Pat. No. 10,808,455 issued Oct. 20, 2020) entitled “Wired Pocket With Lighting.” U.S. application Ser. No. 18/532,816 filed Dec. 7, 2023 entitled “Wired Pocket With Exterior Lighting.” All of which are hereby incorporated by reference in their entirety for all purposes.

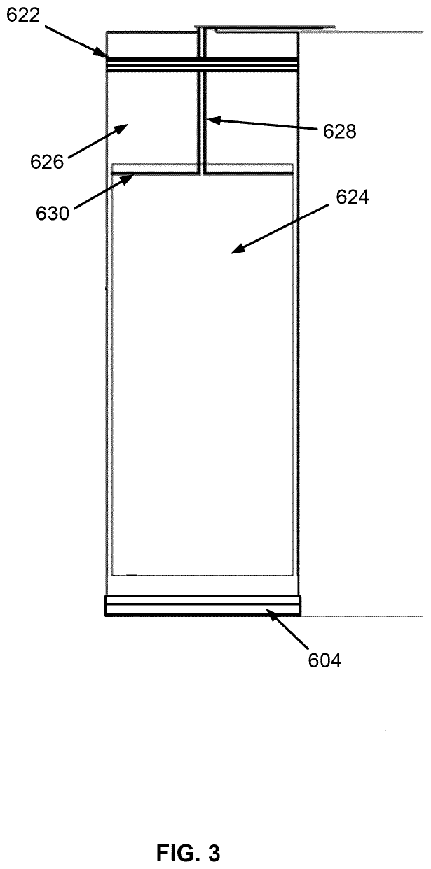

With respect to FIGS. 1 and 3, in various embodiments, the PV film system 110 may include exposed hembar 604, spline 622, PV cells 624, PTE backing 626, bus bars 628 and conductors 630. The conductor 630 may be set further down the PV backing, such that the conductor 630 extends across the top of the PV cells. The energy generated by the PV cells 624 may travel through the conductor 630, across the bus bar 628, through the wiring 530, across the slip ring 500 and to a battery. The storage device (e.g., battery) be part of one or more of the motors or may interface with one or more of the motors. The battery may also interface with any other electrical components discussed herein, or interface within or outside of the system (e.g., lights, electric louvres, etc.). The system may be configured to expose the maximum amount of PV cells to the sunlight. To save on the costs of installing additional PV cells, the system may also be configured to not include excess PV cells that may not be exposed to a sufficient amount of sunlight. As such, the system may not include PV cells on the top portion of the PTE backing 626. The height of the top portion without PV cells may be adjusted, depending on the location and/or size of the window being covered by the window shade system. For example, the height of the top portion (without the PV cells) may be about 14 inches. The PTE backing 626 may include PV cells over a portion of the PV backing. The bottom of the PV backing that includes the hembar 604 may not include PV cells.

In various embodiments, the system may achieve net-zero energy for buildings and other structures. Any portion of the system may interface with, communicate with and/or power a window shade management system (e.g., control system 130), a building management system, an HVAC system and/or a lighting system. In other words, the PV film system 110 may or may not include a window shade system 105. As such, the various features and functions discussed herein may be included directly into a PV film system 110. The system may include networked intelligence. The system may monitor and/or optimize power generation and power usage based on, for example, types of load (e.g., continuous or non-continuous) and power uses. The system may manage the reporting of the performance of the system, the reporting of energy savings and when the building may qualify for tax credits. The system may also allow for customization of any of the features discussed herein.

In various embodiments, and as set forth in FIG. 2, the system 100 may include one or more motors 115, wherein each motor 115 may operate a window shade system 105 and/or a PV film system 110. However, in some embodiments, a motor 115 may operate more than one window shade system 105 and/or more than one a PV film system 110. The motors 115 (and/or other devices in system 100) may be intelligent and networked via POE, serial, wireless and/or other communications technologies.

In various embodiments, the system may include a controller 120. Controller 120 may be part of one or more motors, interface with one or more motors, interface with one or more of the other components set forth herein or be a room controller. The controller 120 may control solar power, POE power, auxiliary power, battery storage 125, battery power, network to shades communication (discontinuous powered nodes) and network to shades or lights communication (continuous powered nodes). For more details about controllers, POE and battery back-up systems, see U.S. Ser. No. 17/463,396 entitled “Window Shade System Power Management” filed on Aug. 31, 2021, which is hereby incorporated by reference in its entirety for all purposes.

In various embodiments, and with continued reference to FIG. 2, the controller 120 that previously controlled different shade systems 105 can now also control different PV film systems 110. The controller 120 may incorporate or interface with a maximum power point tracking (MPPT 123) charge controller. An MPPT 123 may include an algorithm that may be included in a controller 120 for extracting maximum available power from a PV film system 110 under certain conditions. The voltage at which the PV film 110 system may produce maximum power may be known as maximum power point (or peak power voltage). The controller 120 may also interface with the PV film system 110 and receive solar power (e.g., via the MPPT 123). The controller 120 may interface with and receive POE power from a POE switch 135 (and/or an ethernet switch). The controller 120 may further interface with an energy storage device (e.g., battery 125). The POE power and/or the solar power may trickle charge the battery 125, based on battery type and available energy from the PV film 110. When the solar power trickle charges the battery 125, then the POE or ethernet power may be used as a backup power source. The controller 120 may also interface with and receive auxiliary DC power (e.g., 24V) from a building emergency power system (e.g., building power grid). Because the controller 120 is already interfacing with the building emergency power system, the controller 120 (e.g., via the MPPT 123) may receive the solar power generated by the PV film 110 and send at least a portion of the solar energy to the building emergency power system and/or other building accessories.

In various embodiments, the energy from the PV film system 110 may be transmitted directly to the MPPT 123. The MPPT 123 may receive the solar power and the MPPT 123 may serve as a backup power source for the controller 120. The MPPT 123 may provide the backup power to the building emergency power system, and the building emergency power system may provide that backup power to the controller 120. A control system 130 may interface with an input port in the POE switch 135 such that the control system 130 may control and/or monitor the controller 120. The same interface may allow the control system 130 to also monitor the generation and power from the PV film system 110, along with managing the automation of the shade system 105 and/or PV film system 110.

In various embodiments, the PV film 110 may be installed such that the PV film 110 covers at least a portion of a window or opening at all times. In various embodiments, the PV film 110 may be configured to be controlled manually (by the occupant, remote user, facility, owner, etc.) extending and retracting the PV film 110 when desired. In various embodiments, the window shade system 105 may be controlled automatically and optimized independent of the PV film system 110. In various embodiments, the window shade system 105 may be controlled automatically and optimized in conjunction with the PV film system 110.

In various embodiments, the PV film system 110 may be automatically controlled by any control system 130 and/or reporting system. An existing shade control system 130 may be adjusted, supplemented or expanded to work with a PV film system 110 and provide power generation management and/or control functions. For example, the control system and/or reporting system may optimize heat gain reduction, glare reduction, view optimization, etc. for the PV film 110 and/or the shade system 105. The same control and/or reporting system may be used for controlling and/or reporting on both the PV film system 110 and the shade system 105. A different control and/or reporting system may be used for controlling and/or reporting on just the PV film system 110 or the shade system 105. The automatic control may optimize and/or balance the power generation, human consumption and building consumption of daylight, view, solar heat gain, etc.

The system may optimize the PV characteristics, or the PV characteristics may be selected for desired conditions. The PV characteristics may include targeting specific wavelengths (visible light, UV, IR). The PV characteristics, efficiency and/or performance may be impacted by any window glazing (e.g., window tint, etc.), so the PV characteristics may be optimized to compensate for any window glazing. The system may receive information about the PV composition of the PV film 110, such that the system may determine the benefits of having the PV film 110 over certain windows. For example, if the PV film 110 is sensitive to the IR band and the PV film 110 absorbs solar heat gain when over the window, then the system may not control for solar heat gain when the PV film 110 is over the window. The system may also use artificial intelligence and/or machine learning to monitor, report, optimize, train and/or re-train the control system 130 based on the historical performance of the automation of the PV film system 110.

The PV film 110 may be impacted by infrared (IR) wavelengths such that the PV film 110 may absorb the infrared band from the daylight energy. By absorbing the IR band, the PV film 110 may reduce the solar heat gain that is trapped between the window shade and the window. Such reduction in solar heat gain may be a valuable benefit for the building by the reducing the excess heat in the building that would otherwise need to be cooled down, etc. Therefore, the control system 130 may lower the PV film 110 over the window to help reduce the solar heat gain at certain times of the day. The control system 130 may also raise the PV film 110 and shades such that the system allows the solar heat gain to enter the building (while reducing the generating energy) in order to avoid reducing the heat gain. With automation, the system may optimize based on varying goals. The system may monitor and report on the impacts of the energy generation. The system may support energy billing by identifying the power that was generated, the power that was stored and/or the power that was consumed. The goals of the system may include building performance, human performance (e.g., wellness and comfort) and power generation/storage.

For further information about control systems and reporting systems, this application incorporates by reference for all purposes and in their entireties: U.S. Ser. No. 14/692,868 filed on Apr. 22, 2015 and entitled “Automated Shade Control system 130 Interaction With Building Management System”; PCT Application No. PCT/US2013/066316 filed on Oct. 23, 2013 and entitled “Automated Shade Control system 130 Utilizing Brightness Modeling”; PCT Application No. PCT/US2013/066316; U.S. Ser. No. 13/671,018 filed on Nov. 7, 2012, now U.S. Pat. No. 8,890,456 entitled “Automated Shade Control system 130 Utilizing Brightness Modeling”; U.S. Ser. No. 13/556,388 filed on Jul. 24, 2012, now U.S. Pat. No. 8,432,117 entitled “Automated Shade Control system 130”; U.S. Ser. No. 13/343,912 filed on Jan. 5, 2012, now U.S. Pat. No. 8,248,014 entitled “Automated Shade Control system 130”; U.S. Ser. No. 12/475,312 filed on May 29, 2009, now U.S. Pat. No. 8,120,292 entitled “Automated Shade Control Reflectance Module”; U.S. Ser. No. 12/421,410 filed on Apr. 9, 2009, now U.S. Pat. No. 8,125,172 entitled “Automated Shade Control Method and System”; U.S. Ser. No. 12/197,863 filed on Aug. 25, 2008, now U.S. Pat. No. 7,977,904 entitled “Automated Shade Control Method and System”; U.S. Ser. No. 11/162,377 filed on Sep. 8, 2005, now U.S. Pat. No. 7,417,397 entitled “Automated Shade Control Method and System”; U.S. Ser. No. 10/906,817 filed on Mar. 8, 2005, and entitled “Automated Shade Control Method and System”; and U.S. Provisional No. 60/521,497 filed on May 6, 2004, and entitled “Automated Shade Control Method and System.”

The PV film 110 may be optimized to be more efficient at different levels of solar exposure and at different angles of solar exposure. Such optimization of the PV film 110 may result in maximum power generation over different time periods and for different geodesic locations. In various embodiments, the PV film 110 may be at least partially transparent. In various embodiments, the PV cells may be located on both sides of the PV film 110. Due to the transparency of the PV film 110, certain sun rays may pass through the PV film 110. The system may include an inside window shade behind the PV film 110. The inside window shade may be a light color (white) or metallic, such that the inside window shade may reflect the light (that previously passed through the front of the PV film 110) onto the backside of the PV film 110. Moreover, the inside of the PV film 110 may receive light from the interior light fixtures. These additional sources of light onto the inward-facing surface of the PV film 110 (from the reflection of an internal window shade or from interior light fixtures) enable the PV film 110 to generate additional energy. To maximize energy production, the shade control system 130 may automatically adjust the interior shade to be down during times when more sun light is getting through the transparent PV film 110. The control system 130 may automatically adjust the interior lights to turn on, increase brightness and/or focus the interior lights toward the inward-facing surface of the PV cells during the time when the PV film 110 is down and/or during certain time periods.

The area closer to the window pane typically experiences less shadows from awnings or other objects outside of the window. If the PV film 110 is closer to the window pane, then the PV film 110 may be exposed to more sunlight and less shadows. As such, the system may include the PV film tube unrolling the PV film 110 on the side closest to the window. Moreover, the system may include a rod that pushes the top (and backside) of the PV film 110 toward the window such that the rest of the PV film 110 falls downward closer to the window.

Furthermore, if the PV film 110 is angled toward the sun and more perpendicular to the sun, then the PV film 110 may be exposed to even more sunlight. As such, the system may include any mechanical or electrical device that may angle the PV film 110 toward the sun. For example, the system may include a pushing rod (or arm) that pushes the bottom of the PV film 110 toward the window such that the surface of the PV film 110 is at an angle that is more perpendicular to the sunlight rays. The pushing rod may include one or more pushing rods. A first end of the pushing rod may be connected to the window frame and/or the windowsill. The first end of the pushing rod may be connected to a cross rod, wherein one or both ends of the cross rod is rotationally connected to the window frame and/or the windowsill. A second end of the pushing rod may include a perpendicular component that attaches to the end of the pushing rod to resemble a T type configuration. If the first end of the pushing rod is connected to the cross rod and the second end of the pushing rod is connected to a perpendicular component, then the components resemble an I type configuration. In various embodiments, the system may include multiple pushing rods that all interface with the perpendicular component and/or the cross rod. The perpendicular component (top of the T) may push against any portion of the PV film 110 to further angle the PV film 110 toward the sunlight and/or move the PV film 110 closer to the window pane.

The system may include angled guide wires or an angled guide track, such that when the PV film 110 is lowered through the guide wires or guide track, the surface of the PV film 110 is at angle that is more perpendicular to the sunlight rays. The system may also include a windowsill that is angled (or a windowsill that includes an angled block on the top of the windowsill), such that the angled windowsill or angled block faces the sun. When the hembar of the PV film 110 hits the angled sill or angled block, the bottom of the PV film 110 is forced forward such that the surface of the PV film 110 is at angle that is more perpendicular to the sunlight rays. The system for angling a PV film 110 may also similarly angle a window shade 105, or both the PV film 110 and window shade 105.

The PTE backing with the PV cells may not be as flexible as textile shade fabric. As such, the PTE backing may not drop down directly off of the tube, and instead, may include a bend radius that extends toward the horizontal direction with respect to the tube. Hembar 604 may include sufficient weight to manage (e.g., reduce) the bend radius of the PTE backing with the PV cells. Allowing the PTE backing to lie more parallel to the window and/or the window shade may allow more sunlight to impact the PV cells.

The system may also include one or more pivot arms (or rods). A first end of the pivot arm may rotatably connect to a side surface (e.g., a side of the window frame). A second end of the pivot arm may connect to any portion of the PV film 110 or the hembar. In various embodiments, a first pivot arm may connect on the first side (or edge) of a PV film 110 and a second pivot arm may connect on a second side (or edge) of the PV film 110. In various embodiments, a first pivot arm may connect on the first end of a hembar and a second pivot arm may connect on a second end of the hembar.

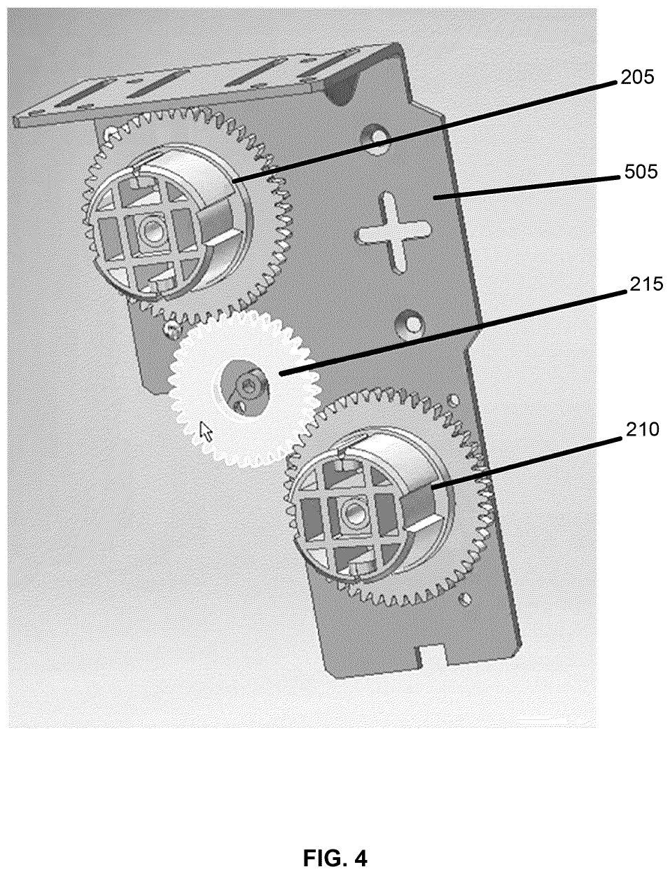

In various embodiments, the one or more pivot arms may interface with a motor, such that the motor lowers the pivot arms. As the motor lowers the pivot arms, the pivot arms may unroll the PV film 110. In various embodiments, the tube that holds the PV film 110 may interface with a motor, such that as the motor rotates the tube, the PV film 110 unrolls and pulls the pivot arms down as the PV film 110 unrolls. Instead of the PV film 110 unrolling parallel to the window, the pivot arms may force the PV film 110 to lower at an angle away from the window. The motor may be configured to interface with a middle gear or belt (similar to FIG. 4) to adjust both the pivot arm and the PV film 110.

The pivot arms may force the PV film 110 into an awning type configuration that angles away from the window, but still provides shade over the window. For example, as the PV film 110 lowers and the pivot arms rotate around 90 degrees (or perpendicular to the window), the pivot arms force the PV film 110 to extend outward to form an awning like configuration. The pivot arms may further rotate past about 90 degrees and pull the PV film 110 and/or hembar closer to the window again. In response to the pivot arms rotating through about 180 degrees, the fully extended PV film 110 may be parallel to the window.

One or more of the pivot arms may include telescoping pivot arms. The telescoping pivot arms may be configured to telescope at different lengths to provide an awning at different angles over the window. The telescoping pivot arms may telescope in response to the motor unwinding the PV film 110 and causing the pivot arms to pivot. The telescoping pivot arms may interface with a motor that forces the telescoping pivot arms to telescope.

The system (e.g., motor) may also interface and/or communicate with various sensors. For example, the system may receive information from a wind sensor. When the wind speed is over a threshold speed, then the system may prevent (e.g., restrict an activation command) the one or more pivot arms (or one or more pushing arms) from extending outward to avoid damage to the pivot arms, pushing arms and/or the PV film 110. The motor may be configured to adjust at least one of the PV film 110, pushing arm and/or the pivot arm, wherein the motor receives input from at least one of a user input device, a motion sensor, other lights, security sensors, a daylight sensor, a brightness sensor, a solar tracking management system, a control system, a reporting system, a scheduling system, a weather sensor and/or any other type of sensor or system. The pivot arms, pushing arms and/or the PV film 110 may adjust to follow a person or object inside or outside of the building. The input to the system may instruct the motor (controlling the pivot arms, pushing arms and/or the PV film 110) to adjust based on factors such as, for example, occupant preference, building manager preference, time of day, seasons of the year, a schedule, motion, daylight, brightness, darkness, solar changes, weather changes and/or the like. The system may include an override feature that allows any user to override any of the automated adjustments of the pivot arms, pushing arms and/or the PV film 110. The sensor may be a security sensor that may be configured to monitor the opening of a window or anything coming through a window. Any of the control systems and/or reporting systems discussed herein or incorporated by reference may provide input for the motor to adjust the angle of the PV film 110 (using any of the systems discussed herein).

In various embodiments, the system may include the window shade 105 and the PV film 110 on the same roller tube. In various embodiments, the system may include the window shade 105 and the PV film 110 on different roller tubes powered by different independent motors 115, different chains or different cordless systems. In various embodiments, the window shade system 105 and/or the PV film system 110 may include a spring with a gravity fed hembar. The PV film 110 may include PV cells on both sides of the PV film 110. When the shade is adjacent to the PV film 110, the shade may include a reflective surface such that the light that comes through the PV film 110 generates energy, then the light is also reflected back to the PV film 110 to generate additional energy.

In various embodiments, and as set forth in FIG. 4, the system may include a bracket 505, wherein the window shade is wound around a first shade tube that is received over a first coupler 205 (that interfaces with a first gear) and the PV film 110 is wound around a second PV film tube 110 that is received by a second coupler 210 (that interfaces with a second gear). As part of the coupler, the gear profile may be molded into the tube plug. The second coupler 210 and the PV film tube 110 may be on the window side, such that the order of items is the window, then the PV film 110, then the shade material 105, then the room. In other words, the PV film 110 unrolls closer to the window and the shade unrolls further from the window and behind the PV film 110. The first shade tube 105 and the second PV film tube 110 may operate together by having the first coupler 205 and the second coupler 210 geared together via one or more middle gears 215. The configuration may be used for manual adjustments (e.g., via a chain) or automated adjustments (e.g., via a motor). The configuration may use one motor 115 that interfaces with either the first coupler 205 or the second coupler 210. The motor 115 may include a motor drive wheel that applies motor torque to drive the tube (e.g., the driving shade tube). A geared motor crown (e.g., part of second coupler 210) interfaces with the motor and the driving tube, such that the geared motor crown transfers the torque of the motor to the idler pinion (e.g., middle gear 215). Middle gear 215 may transfer motion of the tube plug (interfacing with the driving tube) driven by the motor to the tube plug of the driven tube. The driven tube plug (interfacing the with driven tube) receives input from the middle gear 215 to drive the driven tube.

In various embodiments, and with continued reference to FIG. 4, the size and configuration of the middle gear 215 (that couples the first shade tube 105 and the second PV film tube 110) may be used to adjust the gear ratios. Moreover, the number of teeth on the first gear 205, second gear 210 and/or middle gear 215 may be varied to maintain the desired gear ratio. For example, a certain type of fabric or PV film may need more or less torque, speed, etc. Moreover, shades and/or films having different material thicknesses can roll up or down at similar rates. In various embodiments, the couplers and gears that operate the first shade tube 105 and the second PV film tube 110 may be co-planar. In various embodiments, the system may compensate for the thickness differences in the PV film 110 and the window shade fabric 105. In particular, the thicker sheet (and/or different tube sizes) may result in a larger RUD, so different rotation speeds may be implemented for the first coupler 205 and/or the second coupler 210 to allow the sheets to adjust evenly and at the same distance.

In various embodiments, and with continued reference to FIG. 4, the first gear 205 and the second gear 210 may be belted together, but still use one motor 115. For example, the belt may include a cogged belt to help maintain the position of the two shades relative to each other. The plug on the driven tube rotates based on the driving tube motion via the belt. The plug on the driving (input) tube directly reacts to inputs (e.g., chain pull or motor rotation). By belting the tubes together, only one motor 115 may be needed to operate both the shade tube 105 and the PV film tube 110.

The bracket may also include a tensioning system. The tensioning system may tension the belt, to reduce belt slippage and so all tubes stay engaged with the driven tube. In response to loosening the tensioning system, the tube positions may be adjusted relative to one another. The tensioning system may include a tensioner idler (e.g., roller) that applies tension to the belt, while allowing the belt to move. The tensioner idler may be adjustable to provide more or less tension to the belt. The tensioner idler may interface with an adjustment device that may adjust the tensioner idler to different locations to apply more or less tension to the belt. For example, the tensioner idler may interface with a threaded dowel that is received into a threaded hole. As such, the dowel may translate up or down, thereby moving the tensioner idler up or down.

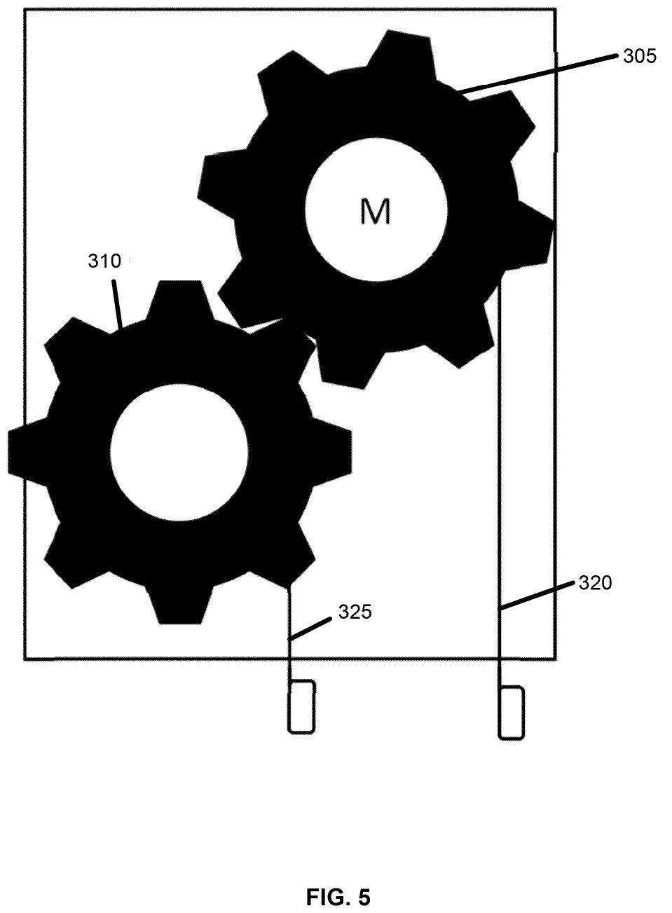

As set forth in FIG. 5, in various embodiments, the first coupler 305 that controls window shade 325 may be geared and the second coupler 310 that controls PV film 110/320 may be geared. The motor 115 may rotate the first coupler 305 such that the gear of first coupler 305 directly rotates the gear of the second coupler 310 (without using a middle gear). The system of FIG. 5 (or any of the configurations discussed herein) may include separate hembars for the PV film 110/320 and for the window shade 105/325.

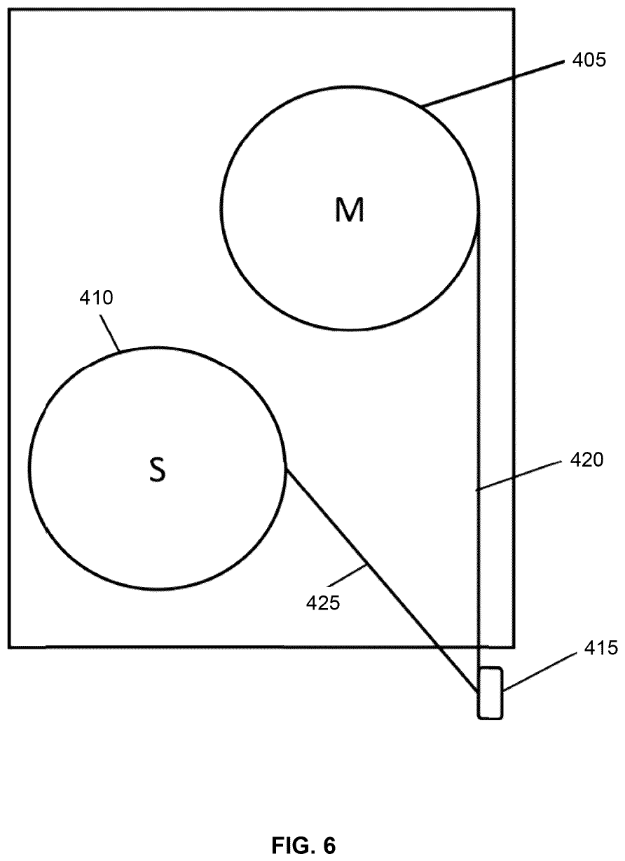

As set forth in FIG. 6, in various embodiments, the system may include the same shared hembar for both the PV film 110/425 and for the window shade 105/420. Motor 115 may adjust window shade 420, but since the same hembar is used for both the PV film 110 425 and for the window shade 420, the adjustment of window shade 420 also adjusts PV film 425. This shared hembar configuration may result in the PV film 425 being angled backward toward the window shade 420 (and not being co-planar with the window pane surface), resulting in poor efficiency. The shared hembar system may include a spring. The shared hembar system may not be impacted by the thickness variations of the PV film 110 and the window shade fabric 105.

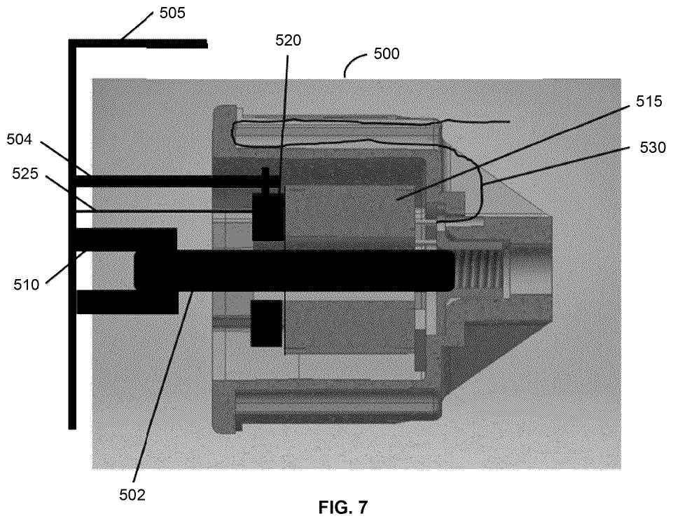

In various embodiments, and as set forth in FIG. 7, the system may include a tube coupler (plug) 500 that receives a tube. The tube coupler 500 may interface with a bracket 505, wherein the rotation and load hanging capabilities of the tube coupler 500 attachment to the bracket 505 are separate from the power connection from the tube to the bracket 505. With this configuration having the power separate from the load, the system limits the impacts from the operation of the load and the resulting wear of the components on the power connection, oxidation and resistance between the PV film 110 and the bracket 505 connection. As such, any deflection of the tube due to weight (the weight of the PV film 110, or the weight of both the PV film 110 and shade) has no or little impact on the integrity of the power connection from the tube to the bracket 505. Separating the power from the load may be more expensive, but such a configuration may allow for higher integrity connections. Moreover, the configuration allows for more flexibility with the configurations and loads of the PV film 110 and the shade 105.

In various embodiments, the system may include a center (idle) pin 502 for the load. The system may not use the center pin 502 (or any other pin) on the tube coupler 500 to transfer power current to (or a return path from) the bracket 505. A first end of the center pin 502 is within a bearing 510 and a second end of the center pin 502 interfaces with (e.g., is screwed into) the tube coupler 500, so the center pin 502 rotates with the tube coupler 500. The tube coupler 500 may also include a slip ring 515, 520 (e.g., an electrical slip ring) for the power distribution. The slip ring 515, 520 may surround the center pin 502 of the tube coupler 500. A stationary section of the slip ring 520 is non-rotating and connects to the bracket 505 via an anti-rotation pin 504. A rotating section of the slip ring 515 rotates with the tube coupler 500. The slip ring 515 includes brushes to transfer the power that is received from the PV film 110 via first connector 530 and out through the bracket 505. Connectors (e.g., wires) may attach to the slip ring 515, 520. A first connector 530 may extend from the rotating section of the slip ring 515, through the tube (e.g., center of the tube) and to the top of the PV film 110. As such, the rotating section of the slip ring 515, first connector 530 and tube all rotate together. When the PV film 110 unrolls, the first connector 530 remains at the top of the PV film 110, so the first connector 530 does not unroll with the PV film 110. A second connector 525 may connect the stationary section of the electrical slip ring 520 through the bracket and out to the MPPT 123. For multi-banded window shades, the first connector 530 and/or the second connector 525 may pass from a first shade to a second window shade to a third window shade, etc.

More specifically, the first connector 530 may have two pins (+, −) that interface with the top of the PV film 110 and the second connector 525 may have two pins 502 (+, −) that interface with the bracket 505. The connection between the pins of the first connector 530 in the rotating section of the slip ring 515 may be bridged by brushes, mercury or any other suitable material or product. The brushes may be 10-20 milliohms. The mercury may be less than 1 milliohm with an electrical transfer and bearing in a material with a very long life and with little to no resistance variation over the lifetime. Therefore, the power from the PV film 110 travels up to the top of the PV film 110, then from the PV film 110 through the first connector 530 across the rotating tube and into the rotating section of the slip ring 515. The power then travels across the brushes to the stationary section of the slip ring 520. The power then travels out through the second connector 525, across the bracket 505 and to the MPPT 123 controller. This slip ring 515, 520 and pin 502 configuration may be built into the tube coupler, recessed into the tube and/or exist on the opposite side of the bracket 505. When this configuration is recessed into the tube, the configuration minimally impacts the space between the edge of the fabric (or edge of tube) and the tube-facing face of the bracket 505. In other words, the configuration does not require a wider distance between the brackets 505.

In various embodiments, the system may include a generator that creates energy by being fed with the kinetic energy from the rotating film tube and/or shade tube. The tubes may not rotate very frequently, so the rotation may provide minimal power generation. However, the system may provide more power generation in buildings that move the PV film tube 110 and/or shade tube 105 more often. If the system includes the shade 105 and the PV film 110 on different tubes, then at least one of the tubes may rotate more often.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices. The AI or ML may store data in a decision tree in a novel way.

We claim:

1. A system comprising:
a controller configured to control one or more motors;
the one or more motors configured to adjust a photovoltaic (PV) film system and a window shade system;
a geared interface configured to interface the PV film system and the window shade system;
the PV film system configured to generate solar power for the controller; and
a storage device that interfaces with the controller, wherein the storage device is configured to store the solar power.

2. The system of claim 1, wherein each of the plurality of motors are configured to adjust the window shade system, such that the adjustment to the window shade system causes an adjustment to the PV film system via the geared interface.

3. The system of claim 1, wherein the geared interface includes a third gear that interfaces with a first gear on the PV film system and second gear on the window shade system.

4. The system of claim 1, wherein the geared interface includes a first gear on the PV film system interfacing with a second gear on the window shade system.

5. The system of claim 1, wherein the PV film system includes a PV film and the window shade system includes a window shade, wherein the PV film and the window shade share a hembar.

6. The system of claim 1, wherein the controller comprises a maximum power point tracking (MPPT) charge controller.

7. The system of claim 1, wherein a power over ethernet (POE) switch interfaces with the controller to provide POE power to the controller.

8. The system of claim 1, wherein an ethernet switch interfaces with the controller to provide data to the controller.

9. The system of claim 1, wherein a control system interfaces with at least one of a POE switch or an ethernet switch, wherein the control system is configured to provide data to the controller for controlling the plurality of motors.

10. The system of claim 1, wherein the PV film system includes a PV film and the window shade system includes a window shade, wherein an inside side of the PV film is configured to receive at least one of artificial light or solar rays reflected from the window shade.

11. The system of claim 1, wherein the window shade system includes a window shade, and wherein one or more pivot arms are configured to angle the window shade outward as the window shade unrolls.

12. The system of claim 1, wherein the window shade system includes a window shade, and wherein a pushing rod is configured to push the window shade closer to a window.

13. The system of claim 1, wherein the window shade system includes a window shade, and wherein a pushing rod is configured to push a bottom of the window shade closer to a window such that the window shade is more perpendicular to solar rays.

14. The system of claim 1, wherein the window shade system includes a window shade, and wherein at least one of an angled windowsill or an angled block is configured to push a bottom of the window shade closer to a window such that the window shade is more perpendicular to solar rays.

15. The system of claim 1, wherein the PV film system includes a slip ring.

16. The system of claim 1, wherein the PV film system includes a coupler with rotation and load hanging functions separated from power connection functions.

17. The system of claim 1, wherein the PV film system includes a coupler that receives a tube, wherein the tube interfaces with a PV film, the coupler further comprising:
a first wire that interfaces with the PV film;
a rotating portion of a slip ring that interfaces with the first wire;
a non-rotating portion of the slip ring that interfaces with a second wire; and
the second wire exiting the coupler.

18. The system of claim 17, wherein the second wire provides solar power to the controller.

19. The system of claim 17, wherein the second wire provides solar power to the MPPT charge controller.

20. The system of claim 1, wherein the controller at least one of is a room controller, is part of the one or more motors, interfaces with the one or more motors, interfaces with the PV film system or interfaces with the window shade system.
